(19) United States
(12) Patent Application Publication
(10) Pub. No.: US 2014/0062913 A1
(43) Pub. Date: Mar. 6, 2014

(54) METHOD FOR DETECTING TOUCH POINT OF MULTI-TYPE OBJECTS

(71) Applicant: AU OPTRONICS CORP., Hsin-Chu (TW)

(72) Inventors: Chin-Min LIN, Hsin-Chu (TW); Sin-Guo Jhou, Hsin-Chu (TW); Yu-Min HSU, Hsin-Chu (TW)

(73) Assignee: AU OPTRONICS CORP., Hsin-Chu (TW)

(21) Appl. No.: 13/795,007

(22) Filed: Mar. 12, 2013

(30) Foreign Application Priority Data
Sep. 6, 2012 (TW) 101132568

(51) Int. Cl. G06F 3/041

(52) U.S. Cl. CPC G06F 3/0416
USPC 345/173

(57) ABSTRACT

A method for detecting touch points of multi-type objects includes: determining whether or not there existing a touch point by a detection of an energy variation below a first effective value; referring the touch point having an area smaller than a first predetermined value as a first-type touch point; referring the touch point having an area larger than a second predetermined value as a second-type touch point; detecting, if there exists the second-type touch point, the energy variation below a second effective value; and determining the coordinate position of the second-type touch point according to the detecting result obtained from the energy variation below the second effective value. The second effective value is larger than the first effective value.

### TECHNICAL FIELD

The present disclosure relates to a method for detecting touch points, and more particularly to a method for detecting touch points of multi-type objects.

### BACKGROUND

Today, touch apparatus has been widely used for data input. With the development of science and technology, the touch means have been evolved from the single-touch manner to multi-touch manner. Today, in the multi-touch technology, various touch operations can be respectively executed by various objects having respective particular contact areas.

Many studies disclose a capacitive touch panel capable of being operated by both a pen tip and a finger tip. However, because the pen and finger have relatively large feedback energy variation therebetween while being touching on a touch panel, the finger touch may result in a relatively wide energy variation if this touch apparatus is particularly designed for pen input; and accordingly the accuracy and linear degree issues are brought in. Alternatively, the pen touch may result in a relatively narrow energy variation if this touch apparatus is particularly designed for finger input; and accordingly this touch apparatus is not so sensitive for the pen touch. In addition, even enhancing the energy variation by increasing the pen tip's area, the touch apparatus may not accurately determine the coordinate position of the pen tip due to the relatively large touch point.

### SUMMARY

An embodiment of the disclosure is to provide a method for detecting touch points of multi-type objects, which includes: detecting an energy variation below a first effective value; determining whether or not there existing a touch point according to the result obtained from the detection of the energy variation below the first effective value; referring, if there exists at least one touch point and one of the touch point(s) has an area size smaller than a first predetermined value, the touch point(s) having an area size smaller than the first predetermined value as a first-type touch point; referring, if there exists at least one touch point and one of the touch point(s) has an area size larger than a second predetermined value, the touch point(s) having an area size not smaller than the first predetermined value as a second-type touch point; detecting, if there exists the second-type touch point, the energy variation below a second effective value; and determining whether or not there truly existing the second-type touch point according to the result obtained from the detection of the energy variation below the second effective value. The second effective value is larger than the first effective value.

Another embodiment of the disclosure is to provide a method for detecting touch points of multi-type objects. The method is adapted to detect a touch apparatus whether or not being touched. The touch apparatus includes a plurality of touch sensing devices. The method for detecting touch points of multi-type objects includes: detecting the touch sensing devices and thereby obtaining a first basic detection result; processing the first basic detection result by a first magnification ratio and thereby obtaining a first scanning result; determining, if the first scanning result indicates that there exists no touch point having an area size larger than a predetermined value, the coordinate position of the touch point belonging to a first-type touch point according to the first scanning result; and executing, if the first scanning result indicates that there exists a touch point having an area size larger than the predetermined value, following operations: detecting the touch sensing devices and thereby obtaining a second basic detection result; processing the second basic detection result by a second magnification ratio and thereby obtaining a second scanning result; determining the coordinate position of the touch point belonging to the first-type touch point according to the first scanning result, and determining the coordinate position of the touch point belonging to the second-type touch point according to the second scanning result.

### BRIEF DESCRIPTION OF THE DRAWINGS

The present disclosure will become more readily apparent to those ordinarily skilled in the art after reviewing the following detailed description and accompanying drawings, in which:

FIGS. 1A, 1B and 1C are schematic flowcharts illustrating a method for detecting touch points of multi-type objects in accordance with an embodiment of the present disclosure;

FIG. 2A is a schematic view illustrating the energy variation distribution resulted from a finger touch based on the first effective value;

FIG. 2B is a schematic view illustrating the energy variation distribution resulted from a pen touch based on the first effective value;

FIG. 2C is a schematic view illustrating the energy variation distribution resulted from a finger touch based on the second effective value;

FIG. 2D is a schematic view illustrating the energy variation distribution resulted from a pen touch based on the second effective value;

FIG.3 is a schematic flowchart illustrating a method of setting an existence of the first-type touch point and obtaining the coordinate position thereof in accordance with an embodiment of the present disclosure;

FIG. 4 is a schematic flowchart illustrating a method of setting an existence of the second-type touch point with an embodiment of the present disclosure;

FIGS. 5A and 5B are schematic flowcharts illustrating a method for detecting touch points of multi-type objects in accordance with another embodiment of the present disclosure; and

FIGS. 6A, 6B and 6C are schematic flowcharts illustrating a method for detecting touch points of multi-type objects in accordance with still another embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

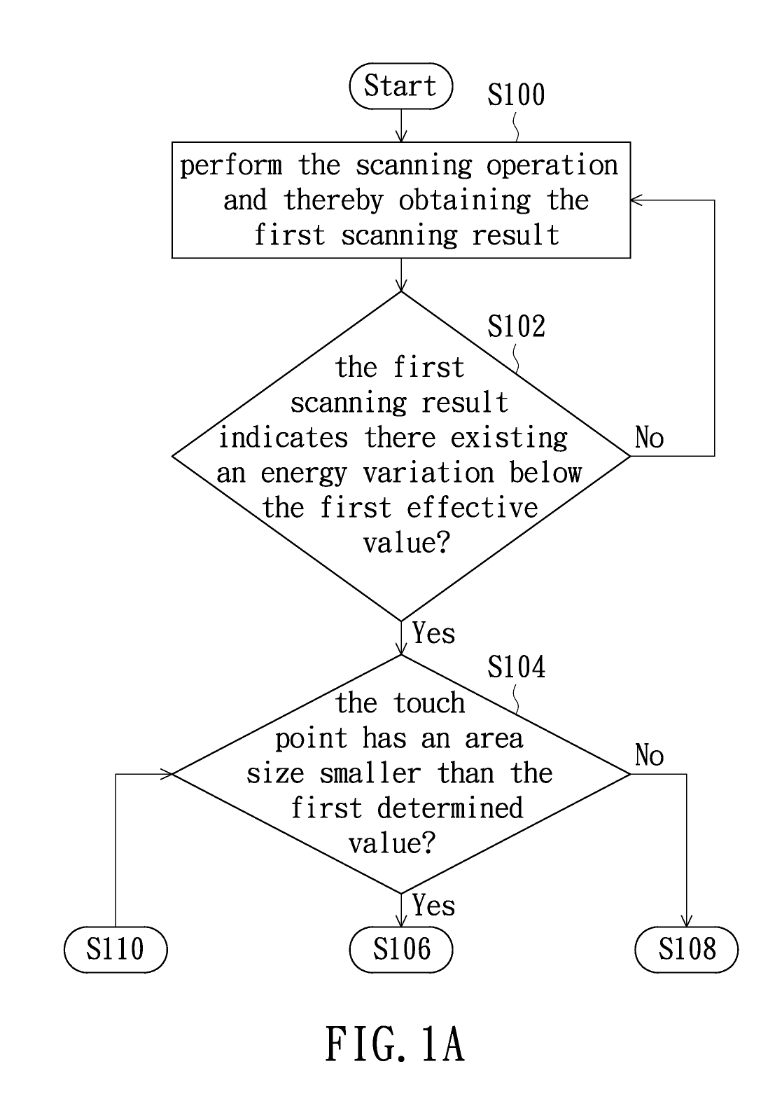

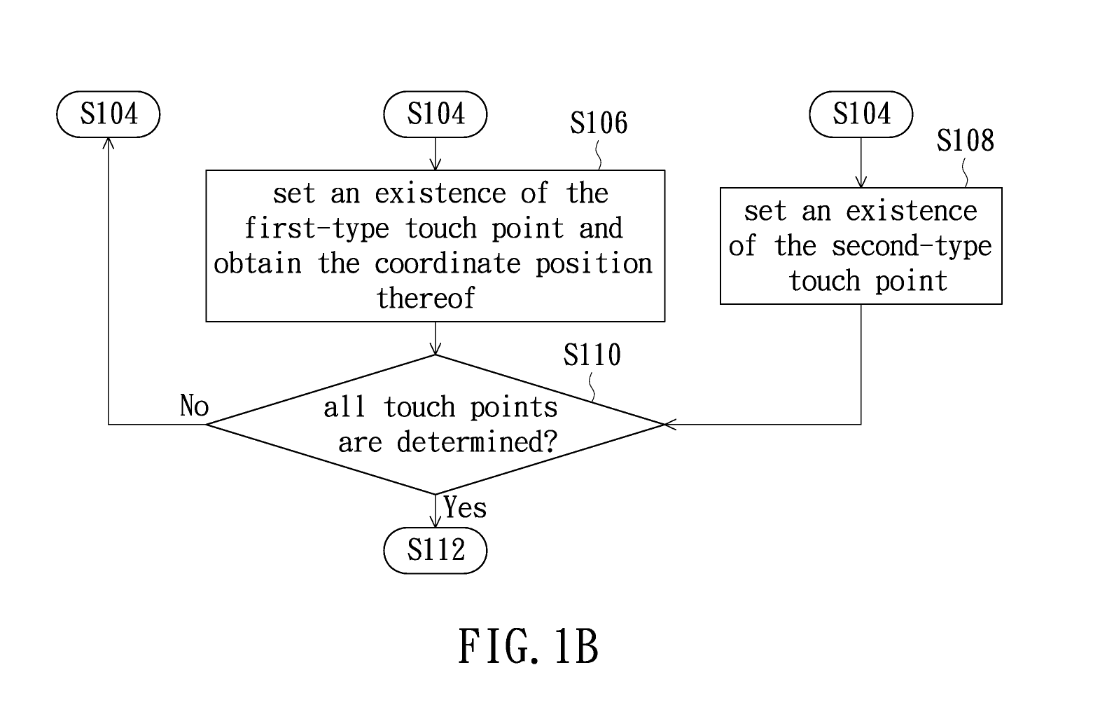

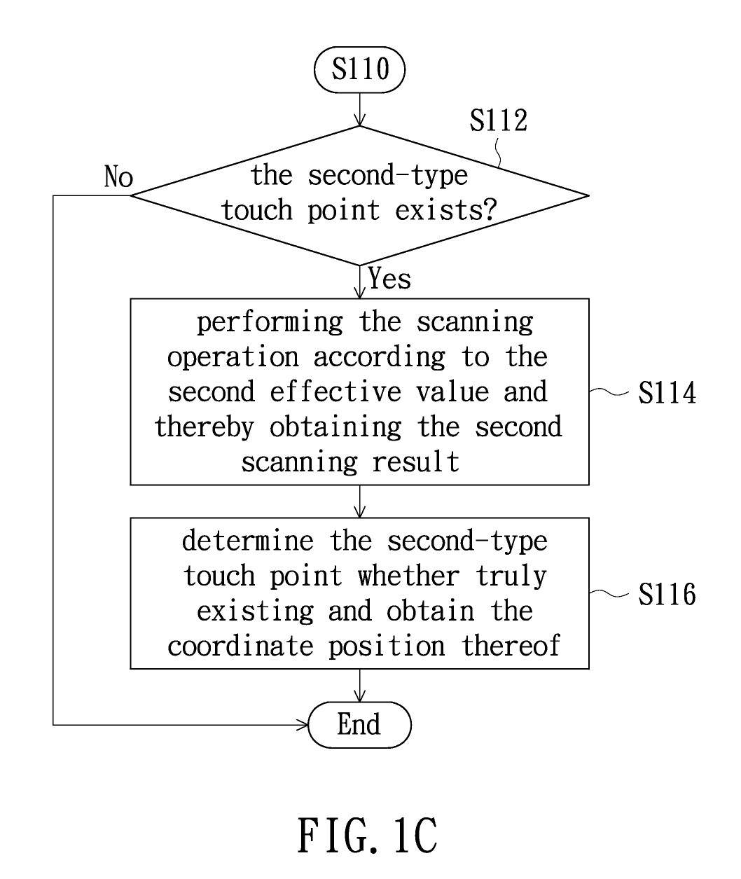

FIGS. 1A, 1B and 1C are schematic flowcharts illustrating a method for detecting touch points of multi-type objects in accordance with an embodiment of the present disclosure. As shown, the method in this embodiment first performs a scanning operation and thereby obtaining a corresponding first scanning result (step S100) and then determines whether or not there existing an energy variation below a particular predetermined value (hereafter is referred to as the first effective value) in the first scanning result (step S102) and accordingly determines whether or not there existing a touch point. The aforementioned energy is, for example, a capacitance or resistance value for detecting an energy variation of a touch panel; and the present invention is not limited thereto.

Specifically, if a touch, resulted by a pen tip, on a panel of a touch apparatus is assumed to have a maximum of 10 units of energy variation thereon in the scanning result and a touch resulted by a finger tip is assumed to have a maximum of 1000 units, the first effective value accordingly can be set to 10 units and this first effective value is referred to as the upper limit for the energy variation detection in this embodiment. In addition, an energy variation below a particular degree is regarded as a noise rather than being resulted from a touch; wherein the energy variation smaller than 5% of the first effective value is considered as a noise in this embodiment. In other words, any energy variation larger than 10 units is always referred as 10 units of energy variation in step S102, and any energy variation smaller than 0.5 unit (i.e., 5% of 10 units) is always referred as a non-touch status; therefore, the first effective value has an effective range from 0.5 to 10 in this embodiment.

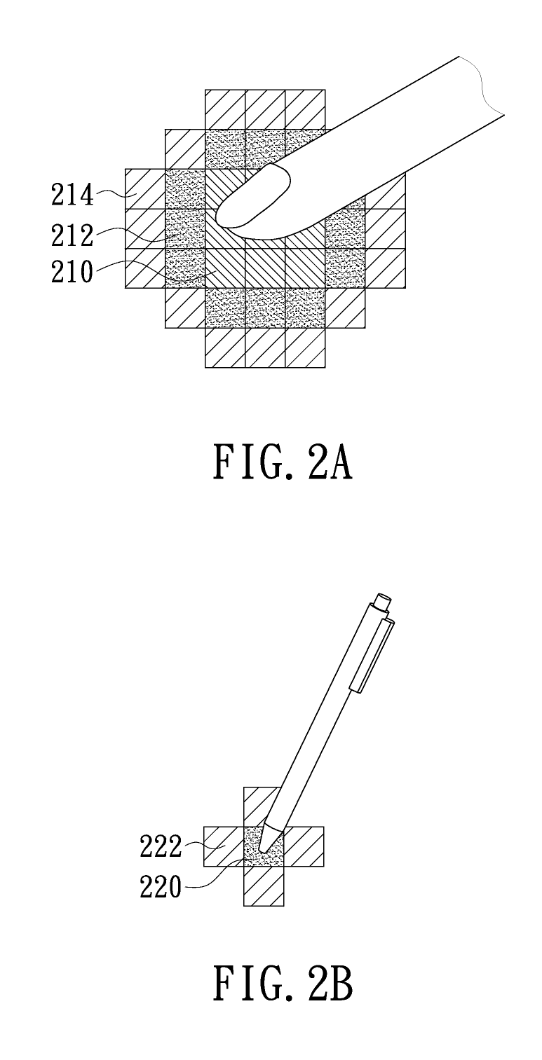

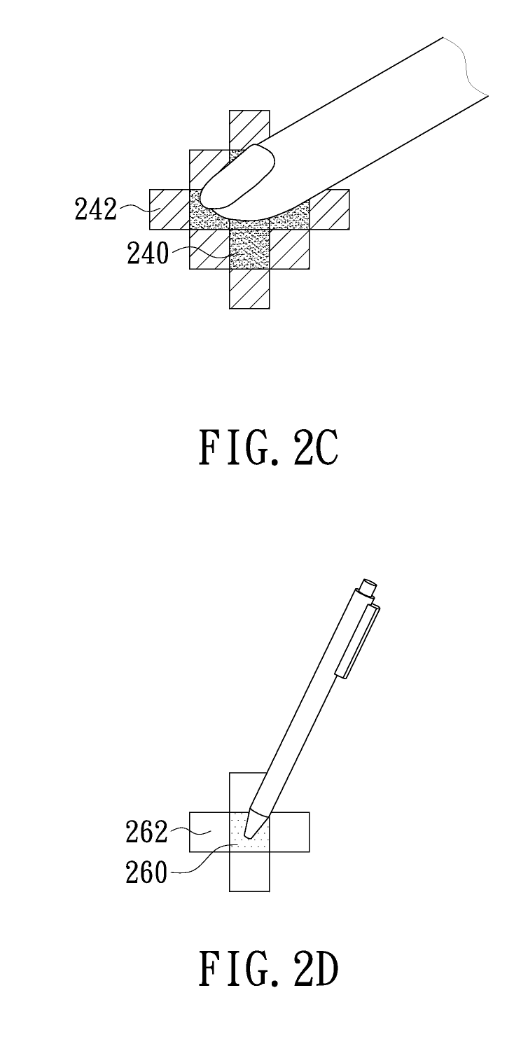

Please refer to FIGS. 2A and 2B, which are schematic views illustrating the energy variation distributions resulted from a finger and pen touches based on the aforementioned first effective value, respectively. As shown in FIG. 2A, because the finger generates, compared with the pen, a relatively large contact area and energy variation, the areas 210 (the more-dense-hatched areas), directly being touched by the finger, each have an energy variation larger than 10 units; the areas 212 (the cross-hatched areas), surrounding the areas 210, each have an energy variation about 0.5˜10 units, which is distinguishable for a touch determination; and the most outer areas 214 (the less-dense-hatched areas) each have an energy variation smaller than 0.5 unit. On the contrary, as illustrated in FIG. 2B, because the pen generates a relatively small contact area and energy variation, the area 220 (the cross-hatched area), directly being touched by the pen, has an energy variation 0.5˜10 units, and the outer areas 222 (the less-dense-hatched areas) each have an energy variation smaller than 0.5 unit.

In step S102, it is understood that there exists at least one energy variation located within the valid range of the first valid value (i.e., 0.5˜10 units) in the first scanning result if the touch pressure on the touch panel is larger than a threshold; in other words, any touch pressure larger than a threshold can result in at least one touch point on the touch panel. Alternatively, the touch apparatus is determined not being touched if there exists no any energy variation within the effective range of the first effective value (0.5˜10 units) in the first scanning result, and consequently the method in this embodiment shown in FIGS. 1A, 1B and 1C goes back to step S100 for performing the scanning operation again. On the contrary, the method determines the type of the touch point (step S104) if there exists at least one energy variation located below the first effective value in step S102.

As illustrated in FIGS. 2A, 2B, because the first effective value is set to relatively low (10 units), the pen's coordinate position (e.g., the area 220 in FIG. 2B) can be located more accurately but oppositely the finger's coordinate position (e.g., the areas 210, 212 in FIG. 2A) cannot be located so accurately. Thus, an area size distinguishing mechanism, for determining that a touch point belongs to a first-type touch point (for example, resulted from a pen) or belongs to a second-type touch point (for example, resulted from a finger), is introduced in step S104. As mentioned above, because the two types of objects (pen and finger) have a relatively-large energy variation gap therebetween, the touch areas respectively resulted from the two types of object can be obviously distinguished by appropriately setting the first effective value. Thus, by appropriately defining a predetermined value (hereafter is called the first predetermined value) located between the area sizes respectively resulted from a pen and a finger, the two types of objects (pen and finger) can be distinguished accurately. Specifically, the method goes to step S106 if the touch point is determined as the first-type touch point by having an area size smaller than the first predetermined value in step S104; alternatively, the method goes to S108 if the touch point is determined as the second-type touch point by having an area size larger than the first predetermined value.

It is to be noted that, in this embodiment the two types of objects are distinguished by the first predetermined value only; however, the two can be distinguished by two different predetermined values. For example, in another embodiment, a touch point is determined as a first-type touch point (e.g., resulted from a pen) if having an area size smaller the first predetermined value and is determined as a second-type touch point (e.g., resulted from a finger) if having an area size larger a second predetermined value; wherein the second predetermined value is set larger than the first predetermined value thereby preventing the judgment confusion from occurring.

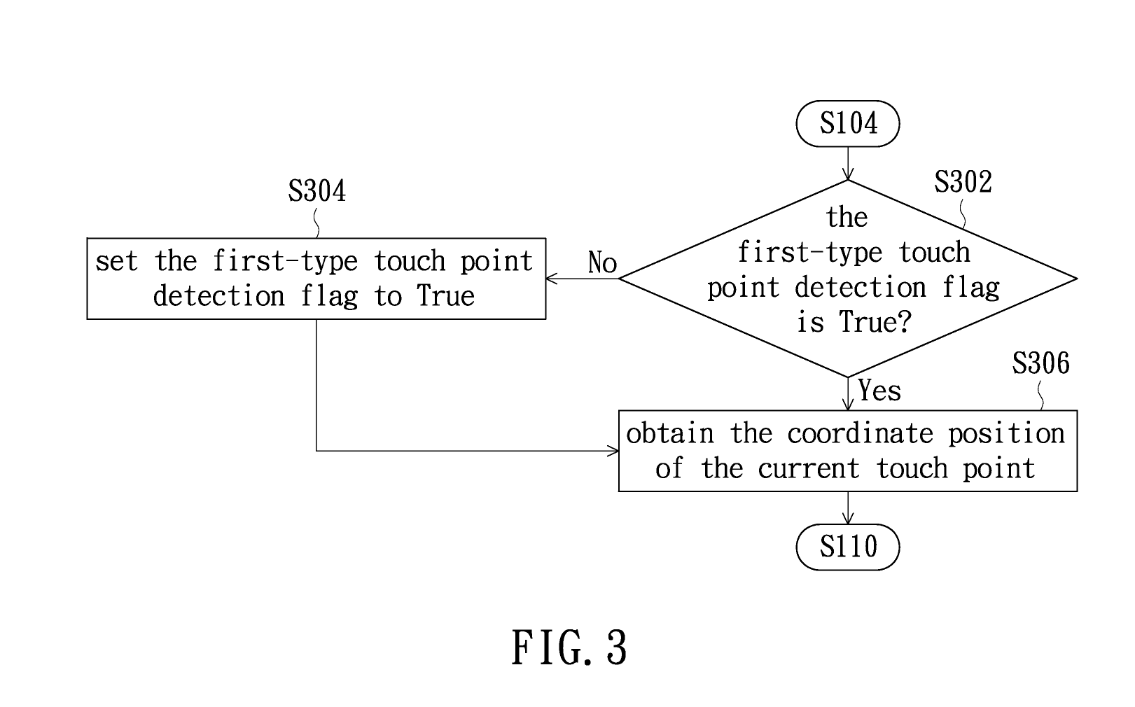

Then, the method sets an existence of the first-type touch point and obtains the coordinate position thereof (step S106) if the touch point has an area size smaller than the first predetermined value. FIG. 3 is schematic flowchart illustrating a method of setting an existence of the first-type touch point and obtaining the coordinate position thereof. As shown, first, the method in this embodiment determines a particular flag (hereafter is referred to as a first-type touch point detection flag) whether or not having a value of True (step S302). The touch point detection flag herein is used to indicate the existence of a touch point; specifically, there exists a touch point if the touch point detection flag is True, and there exists no touch point if False. In this embodiment, there exists a first-type touch point if the first-type touch point detection flag is True, and there exists no first-type touch point if False. Afterwards, the method sets the first-type touch point detection flag to True (step S304) if the first-type touch point detection flag is False in step S302, and consequently obtains the coordinate position of the current touch point (specifically, the first-type touch point) (step S306). Alternatively, the method directly goes to step S306 if the first-type touch point detection flag is True in step S302.

To those ordinarily skilled in the art, it is understood that the method in this embodiment can omit step S302 and directly set the first-type touch point detection flag as True; and accordingly, the method directly moves from step S104 to step S304 and then step S306. Thus, the method can have a benefit of one step less; but on the other side, the operation of writing True to the first-type touch point detection flag must be always executed without any condition.

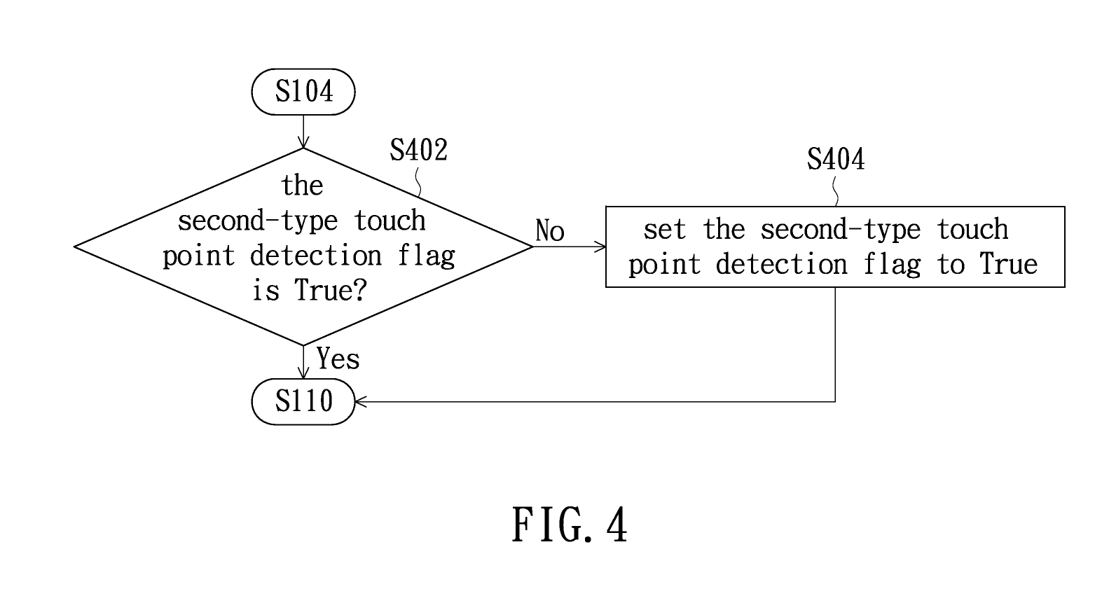

Please refer to FIGS. 1A, 1B and 1C again. The method in this embodiment sets an existence of the second-type touch point (step S108) if the current touch point is determined to have an area size not smaller than the first predetermined in step S104. FIG. 4 is a schematic in-detailed flowchart illustrating a method of setting an existence of the second-type touch point in accordance with an embodiment of the present disclosure. As shown, first, the method in this embodiment determines a particular flag (hereafter is referred to as a second-type touch point detection flag) whether or not having a value of True (step S402). Specifically, there exists a second-type touch point on the touch apparatus if the second-type touch point detection flag is True, and there exists no second-type touch point if False. Afterwards, the method sets the second-type touch point detection flag to True (step S404) if the second-type touch point detection flag is False in step S402, and consequently obtains the coordinate position of the current touch point (specifically, the second-type touch point) (step S110). Alternatively, the method directly goes to step S110 if the first-type touch point detection flag is True in step S402.

Likewise, to those ordinarily skilled in the art it is understood that the method in this embodiment can omit step S402 and directly set the second-type touch point detection flag as True; and accordingly, the method directly moves from step S104 to step S404 and then step S110. Thus, the method can have a benefit of one step less; but on the other side, the operation of writing True to the second-type touch point detection flag must be always executed without any condition.

It is to be noted that, only the processes of setting the first-type and second-type touch point detection flags as True are mentioned in above-mentioned steps but without mentioning the processes of setting the first-type and second-type touch point detection flags as False, this is because the operation of setting the first-type and second-type touch point detection flags as False is not always necessarily executed in steps S106, S108. In an embodiment, the two flags can be set to False together with the execution of the scan operation in step S100, and then further processed in either step S106 or S108. Specifically, the first-type touch point detection flag is set to True in step S106 if there exists the first-type touch point; and the second-type touch point detection flag is set to True in step S108 if there exists the second-type touch point. Alternatively, the first-type touch point detection flag is set to False in step S106 if there exists no first-type touch point; and the second-type touch point detection flag is set to False in step S108 if there exists no second-type touch point. In another embodiment, the numbers of the first-type and second-type touch points are counted by a counter first, and the first-type and second-type touch point detection flags are then set either as True or False according to the aforementioned counting numbers.

Please refer to FIGS. 1A, 1B and 1C again. After the step S106 or S 108, the method in this embodiment confirms that whether or not all of the touch points have been processed by step S104 (step S110). Specifically, if there exists any touch point not being processed yet, the method moves back to step S104 for determining the area size of the non-processed touch point; alternatively, the method determines whether or not there existing the second-type touch point (step S112) if all the touch points have been processed by step S104. It is understood that the existence of second-type touch point can be determined by the second-type touch point detection flag if the method illustrated in FIG. 4 is adopted in step S108. Afterwards, the method goes to the END if the second-type touch point is not found in step S112; alternatively, the method goes to step S114 for further processing the second-type touch points if the second-type touch point is found in step S112.

To precisely calculate the coordinate position, the method performs the scanning operation again and thereby obtaining a second scanning result if there exists the second-type touch point in step S112 (step S114), and a processor (not shown) is configured to determine whether or not there substantially existing the second-type touch point according to the second scanning result obtained by the touch sensing devices (step S116); wherein, the process in this embodiment can determine whether or not the touch point exactly is a second-type touch point according to the information, such as touching area of each touch point, contained in the second scanning result. In other words, the step 112 may determine that there exists a second-type touch point; however, this second-type touch point may be regarded as a noise by the second scanning result, which is obtained by a scanning operation according to the second effective value in step S114, due to having relatively low energy therein, and accordingly the “touch point” existing in step S112 is not actually existed in this embodiment. In addition, the second-type touch point determined in previous may still have a relatively large area size in the second scanning result, and accordingly the object type of this second-type touch point can be further to be determined according to the second scanning result.

In one implementation mean, the method performs one scanning operation in step S100 and another scanning operation in step S114. Moreover, to those touch panels having an X-axis and Y-axis both capable of being supplied with scan signals, the first-time scanning operation can be realized by inputting signals from the X-axis and sequentially detecting signals from the Y-axis (or, inputting signals from the Y-axis and sequentially detecting signals from the X-axis) and the second-time scanning operation can be realized by inputting signals from the Y-axis and sequentially detecting signals from the X-axis (or, inputting signals from the X-axis and sequentially detecting signals from the Y-axis). Because the two scanning operations are performed in two different directions, different detection standards can be designed in this embodiment. For example, by setting different effective values or gain values (Gains), the energy variations can be adjusted to be more distinguishable.

In another implementation mean, the scanning result is adjusted by modulating (e.g., increasing) the first effective value. In other words, the energy data obtained by the scanning operation performed in the step S100 is still used as the fundamental measurement standard in the follow-up process; however, in this implementation mean, the first effective value (e.g., 10 units) is raised up to the second effective value (e.g., 1000 units) in step S114, accordingly the energy variation below 50 units (5% of the 1000 units) is regarded as a noise; wherein the corresponding energy variation distributions resulted from touches by using a finger and a pen based on the aforementioned second effective value are illustrated in FIGS. 2C, 2D, respectively. As shown in FIG. 2C, by adopting the second effective value as the fundamental measurement standard, the effective touch areas 240, resulted by finger touch and having an energy variation located between 50˜1000 units, have an area size much smaller than that as illustrated in FIG. 2A; wherein the energy variation below the second effective value (50 units) resulted in the areas 242 is regarded as a noise. Because the determination of a touch point is only associated with the areas 240 and nothing to do with the areas 242, the coordinate position of the touch point resulted by a finger as illustrated in FIG. 2C can be determined more accurately, compared with that as illustrated in FIG. 2A. In this implementation mean as illustrated in FIG. 2D, neither the area 260 being touched by a pen or the areas 262 are treated as touch points due to both have energy variations (generally, the energy variation resulted by a pen is below 10 units) smaller 50 units.

It is understood that the aforementioned embodiment can have some mobilizations in response to actual design requirements. For example, the method in this embodiment can omit steps S108, S112, for the determination of whether or not there existing the second-type touch point, by always executing steps S114, S116 for determining whether or not there existing the second-type touch point and consequently determining the coordinate position thereof. In addition, it is to be noted that the method in this embodiment may move to step S100, for another complete process of detecting touch point of multi-type objects, by the end of either step S112 or step S116.

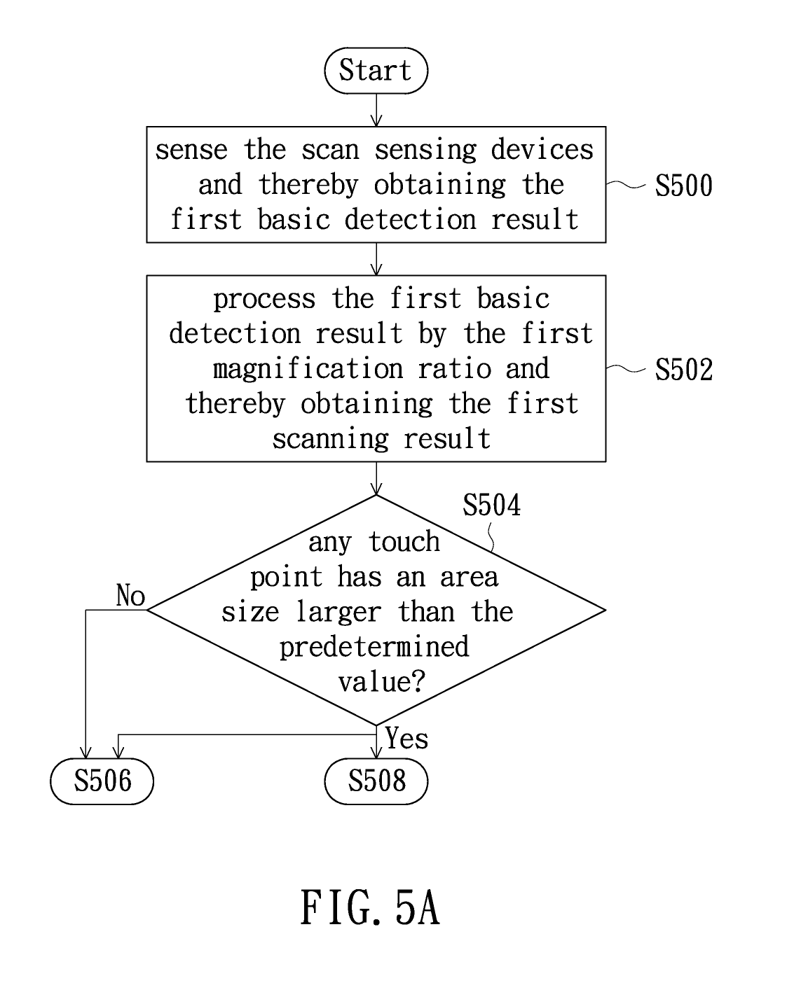

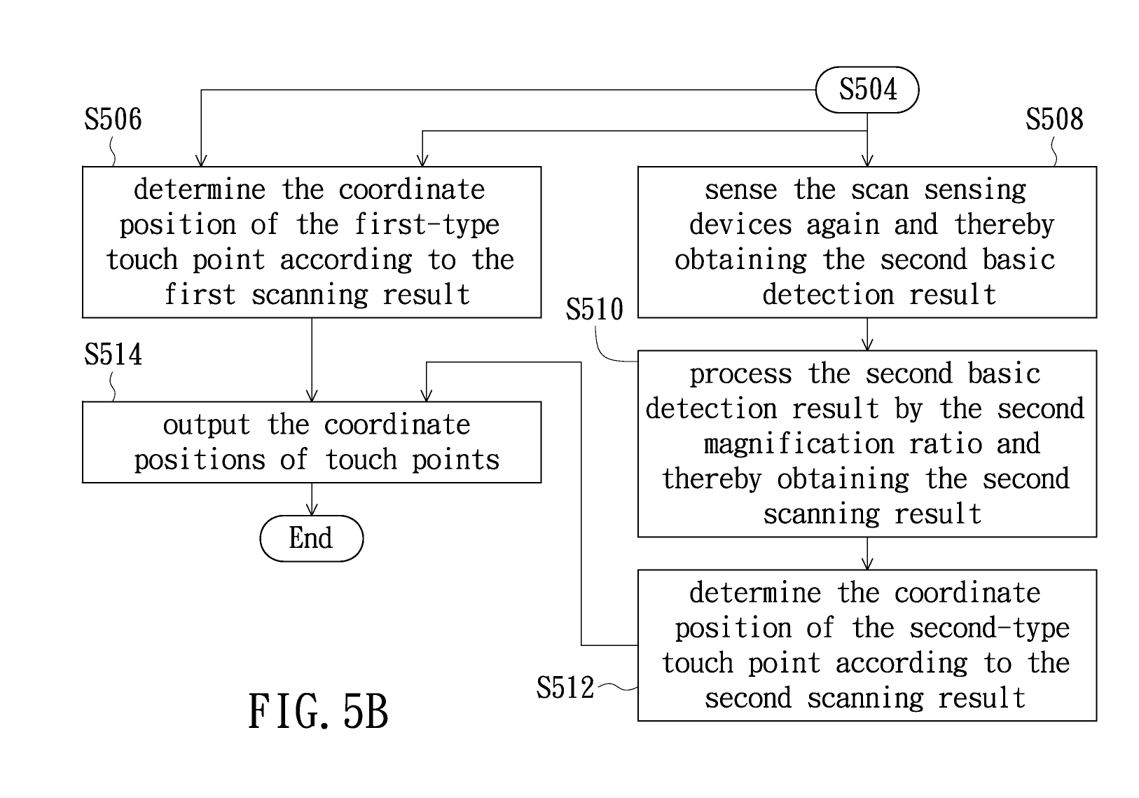

FIGS. 5A, 5B are schematic flowcharts illustrating a method for detecting touch points of multi-type objects in accordance with another embodiment of the present disclosure. In this embodiment, the method first obtains a first basic detection result by sensing touch sensing devices (step S500), and performs a magnifying operation on the first basic detection result by a particular magnification ratio (hereafter is referred to as the first magnification ratio) and thereby obtaining a corresponding first scanning result and temporarily stores the first scanning result in a register set (step S502). Next, the method determines whether or not there existing any touch point having an area size larger than a predetermined value (for example, the first predetermined value in the previous embodiment) by using the aforementioned first scanning result (step S504). If there is no any touch point having an area size larger than the predetermined value, the method refers the touch point as a first-type touch point and directly determines the coordinate position thereof according to the first scanning result (step S506) and consequently outputs the obtained first-type touch point's coordinate position (step S514); alternatively, the method, beside performing step S506 and thereby determining the first-type touch point's coordinate position, also senses the touch sensing devices and thereby obtaining a second basic detection result (step S508). Likewise, the method performs the magnifying operation on the second basic detection result by another particular magnification ratio (hereafter is referred to as the second magnification ratio) and thereby obtaining a corresponding second scanning result (step S510). Afterwards, the method refers the touch point as a second-type touch point and determines the coordinate position thereof according to the second scanning result (step S512), and the second-type touch point's coordinate position together with the first-type touch point's coordinate position obtained in step S506 are outputted for the follow-up processing (step S514). The determination of the touch point's coordinate position can be realized by various means; for example, a coordinate position with less noise interference can be obtained by using the average or differential operational operations on the touch points.

It is understood, to those ordinarily skilled in the art, that the implementation of this embodiment may have some modifications. For example, in step S504, the method can first determine whether or not there existing touch points before the determination of whether or not there existing any touch point having an area size larger than the predetermined value; accordingly, the method directly moves to step S514, without the execution of steps S506˜S512, if there is no any touch point being detected. In another example, the obtainment of the first and second basic detection results can be realized by sensing the touch sensing devices in the same direction; or in two different directions as illustrated in the previous embodiment, that is, the first-time scan operation is performed by inputting signals from the X-axis and sequentially detecting signals from the Y-axis (or inputting signals from the Y-axis and sequentially detecting signals from the X-axis) and the second-time scan operation is performed by inputting signals from the Y-axis and sequentially detecting signals from the X-axis (or inputting signals from the X-axis and sequentially detecting signals from the Y-axis).

It is understood, to those ordinarily skilled in the art, that the technique provided in the present invention can be realized by various implementations under the same designing spirit; for brevity, no any unnecessary detail is given here.

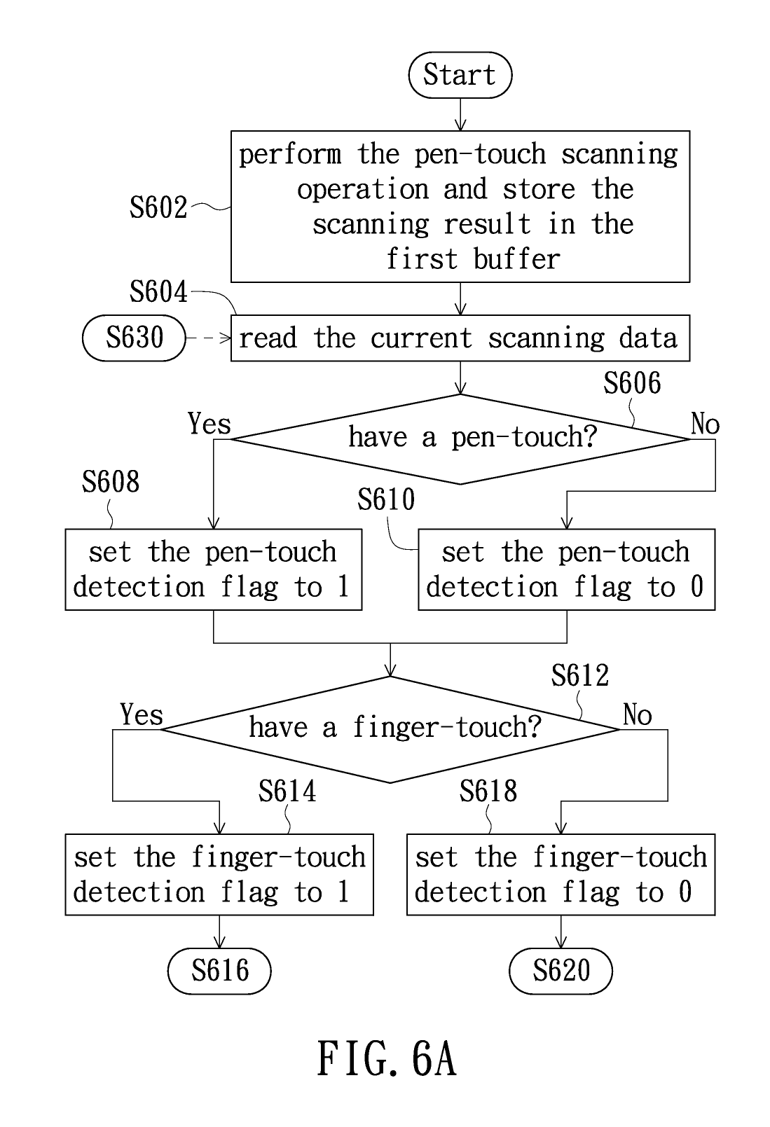

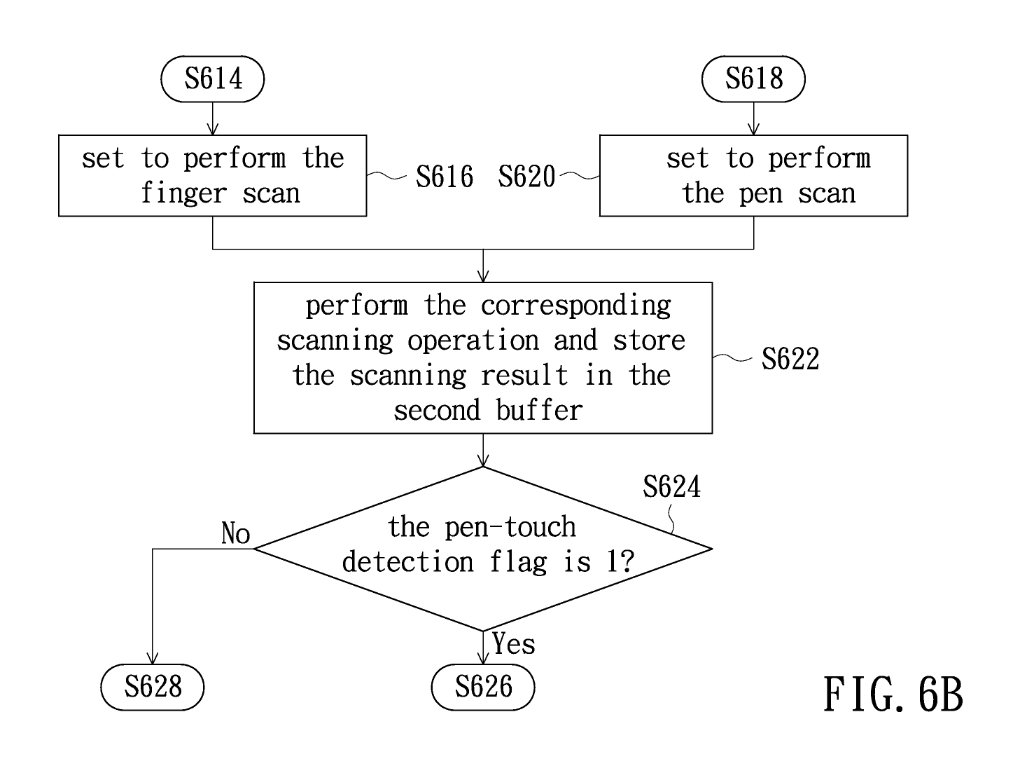

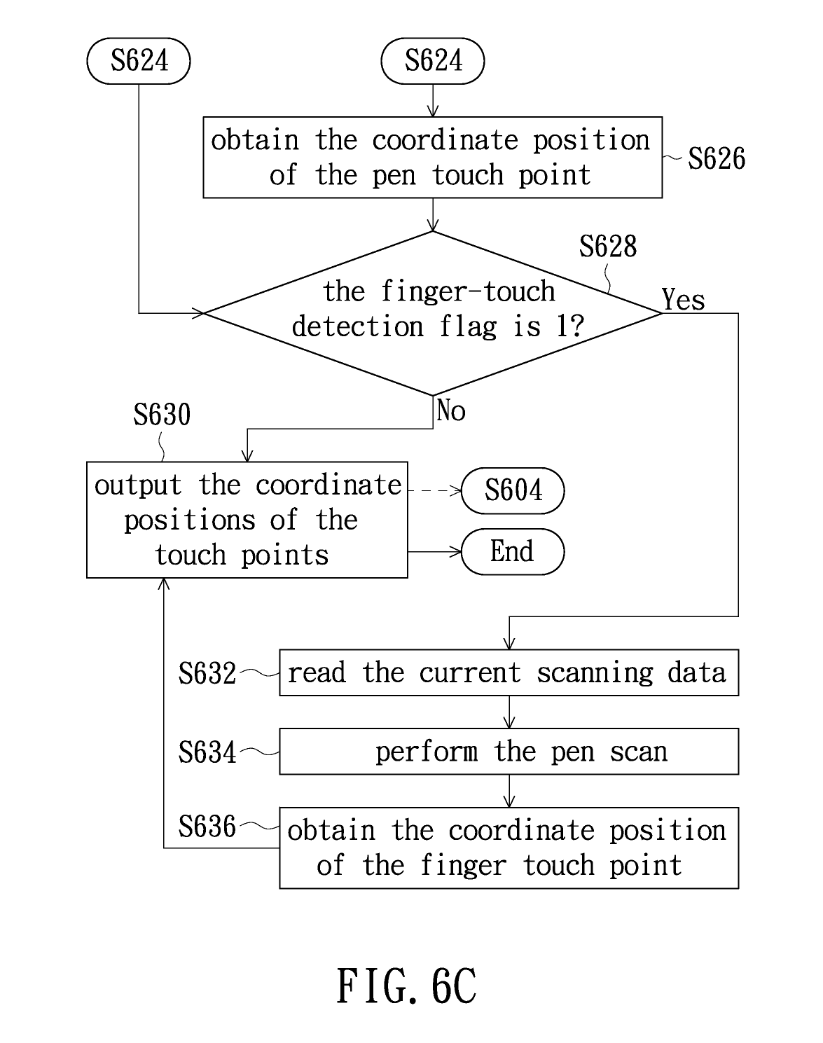

Next, please refer to FIGS. 6A, 6B and 6C, which are schematic flowcharts illustrating a method for detecting touch points of multi-type objects in accordance with still another embodiment of the present disclosure. In this embodiment, the aforementioned first-type touch point is specifically resulted by a pen tip and the second-type touch point is specifically resulted by a finger tip; by the specific definition, the design features of this embodiment can be described much more clearly.

As illustrated in FIGS. 6A and 6B, the method in the embodiment first performs a pen-touch scanning operation and stores the scanning result in a first buffer (step S602); wherein the pen-touch scanning operation herein is referred to the scanning operation for determining whether or not there existing a touch point resulted by a pen tip, and the implementation of the pen-touch scanning operation can be obtained from FIG. 1 and the descriptions associated with the first-type touch point in the previous embodiments. In addition, a finger-touch scanning operation mentioned in follows is referred to the scanning operation for determining whether or not there existing a touch point resulted by a finger tip, and the implementation of the finger-touch scanning operation can be obtained from FIG. 1 and the descriptions associated with the second-type touch point in the previous embodiments.

Then, the method reads the current scanning result (step S604). Specifically, the corresponding data is read from the first buffer if the current scanning result is stored therein; or, the corresponding data is read from a second buffer if the current scanning result is stored therein. After reading the data, the method determines whether or not there existing a pen-touch according to the read data (step S606). If there exists a pen-touch, the method sets a pen-touch detection flag to 1 or True (step S608); alternatively, the method sets the pen-touch detection flag to 0 or False if there exists no pen-touch (step S610). Likewise, the method determines whether or not there existing a finger-touch according to the data read in step 604 (step S612). If there exists a finger-touch, the method sets a finger-touch detection flag to 1 or True (step S614) and consequently sets to perform the finger-touch scanning operation (step S616); alternatively, the method sets the finger-touch detection flag to 0 or False if there exists no finger-touch (step S618) and consequently sets to perform the pen-touch scanning operation (step S620).

After the completion of step S616 or S620, the method performs the corresponding scanning operation and stores the scanning result in the second buffer (step S622). Afterwards, the method determines whether or not the pen-touch detection flag is 1 (step S624). If the pen-touch detection flag in step S624 is 1, the method determines the coordinate position of each pen-touch point by a particular touch point determination mechanism, such as a processor, according to the data read out from the first buffer (step S626). Once the pen-touch detection flag is determined to be 0 in step S624 or after the completion of step 626, the method determines whether or not the finger-touch detection flag is 1 (step S628) for the follow-up process according to the determination result.

If the finger-touch detection flag is determined to be 0 in step S628, the method directly outputs the touch point's coordinate position obtained in previous (step 5630) and consequently moves to the END. Accordingly, the data previously stored in the second buffer in step S622 is used to replace the data read out in the next-round step S604; in other words, the operation of step S622 is equivalent to the operation of step S602 in the next-round process, and the buffer stored with the data obtained in the next-round S604 is the buffer associated with step 622 in this round.

If the finger-touch detection flag is determined to be 1 in step S628, the method reads out the current scanning data (step S632), that is, the method reads out the scanning result obtained in step S622. Then, the method performs another pen-touch scanning operation (step 5634) and stores the obtained data. Afterwards, the method determines the coordinate position of each finger touch point according to the data read out in step S632 (step S636). After the obtainment of the coordinate position, the method outputs the coordinate position of the finger touch point as well as the coordinate position of the pen touch point obtained in previous (step S630). Accordingly, the data previously stored in the buffer in step S634 is used to replace the data read out in the next-round step S604; in other words, the operation of step S634 is equivalent to the operation of step S602 in the next-round process, and the buffer stored with the data obtained in the next-round S604 is the buffer associated with step 634 in this round.

In summary, through first scanning the first-type touch point and then selectively scanning the second-type touch point according to the data obtained from the scanning of the first-type touch point by using respective parameters, the present invention can determine the exact coordinate positions of touch points of multi-type objects. Moreover, because the scanning of the second-type touch point is selectively performed, the present disclosure can have power-saving feature by reducing the number of scanning under a particular condition.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for detecting touch points of multi-type objects, comprising:
detecting an energy variation below a first effective value;
determining whether or not there existing a touch point according to the result obtained from the detection of the energy variation below the first effective value;
referring, if there exists at least one touch point and one of the touch point(s) has an area size smaller than a first predetermined value, the touch point(s) having an area size smaller than the first predetermined value as a first-type touch point;
referring, if there exists at least one touch point and one of the touch point(s) has an area size larger than a second predetermined value, the touch point(s) having an area size larger than the first predetermined value as a second-type touch point;
detecting, if there exists the second-type touch point, the energy variation below a second effective value; and
determining whether or not there truly existing the second-type touch point according to the result obtained from the detection of the energy variation below the second effective value,
wherein the second effective value is larger than the first effective value.

2. The method according to claim 1, wherein the energy variation below the first effective value is sequentially detected in a first direction, and the energy variation below the second effective value is sequentially detected in a second direction, the first direction is different from the second direction.

3. The method according to claim 1, further comprising:
setting, if there exists the first-type touch point, a first-type touch point detection flag to True; and
setting, if there exists no first-type touch point, the first-type touch point detection flag to False.

4. The method according to claim 1, further comprising:
setting, if there exists the second-type touch point, a second-type touch point detection flag to True; and
setting, if there exists no second-type touch point, the second-type touch point detection flag to False.

5. The method according to claim 1, further comprising:
not detecting, if there exists no second-type touch point, the energy variation below the second effective value.

6. The method according to claim 1, further comprising:
determining, if there exists the first-type touch point, the coordinate position of the first-type touch point according to the energy variation below the first effective value.

7. The method according to claim 1, further comprising:
determining, if there exists no second-type touch point, whether or not there existing one or more second-type touch point by re-detecting the energy variation below the first effective value.

8. A method for detecting touch points of multi-type objects, the method being adapted to detect a touch apparatus whether or not being touched, the touch apparatus comprising a plurality of touch sensing devices, the method comprising:
detecting the touch sensing devices and thereby obtaining a first basic detection result;
processing the first basic detection result by a first magnification ratio and thereby obtaining a first scanning result;
determining, if the first scanning result indicates that there exists no touch point having an area size larger than a predetermined value, the coordinate position of the touch point belonging to a first-type touch point according to the first scanning result; and
executing, if the first scanning result indicates that there exists a touch point having an area size larger than the predetermined value, following operations:
detecting the touch sensing devices and thereby obtaining a second basic detection result;
processing the second basic detection result by a second magnification ratio and thereby obtaining a second scanning result;
determining the coordinate position of the touch point belonging to the first-type touch point according to the first scanning result, and determining the coordinate position of the touch point belonging to the second-type touch point according to the second scanning result.

9. The method according to claim 8, wherein the first basic detection result is obtained by sequentially scanning the touch sensing devices in a first direction, and the second basic detection result is obtained by sequentially scanning the touch sensing devices in a second direction, wherein the first direction is different from the second direction.
